(19) United States
(12) Patent Application Publication
(10) Pub. No.: US 2008/0227949 A1
(43) Pub. Date: Sep. 18, 2008

(54) Hydrophilized Polyalkylene Glycol, Production Method Thereof, and Application Thereof

(75) Inventors: Atsuro Yoneda, Toyonaka-shi (JP); Akiko Hemmi, Osaka-shi (JP)

Correspondence Address: CONNOLLY BOVE LODGE & HUTZ LLP, 1875 EYE STREET, N.W., SUITE 1100, WASHINGTON, DC, 20036, US

(73) Assignee: NIPPON SHOKUBAI CO, LTD, OSAKA-SHI (JP)

(21) Appl. No.: 12/088,646

(22) PCT Filed: Sep. 26, 2006
(86) PCT No.: PCT/JP2006/319650

§ 371 Date: Apr. 23, 2008

(30) Foreign Application Priority Data
Sep. 29, 2005 (JP) 2005-284532
Jul. 24, 2006 (JP) 2006-200648

(51) Int. Cl. C08G 65/02

(52) U.S. Cl. 528/391; 528/403

(57) ABSTRACT

To provide: a hydrophilized polyalkylene glycol which is preferably used in various applications, and sufficiently exhibits high performances such as detergency; a production method thereof; and an application thereof. A hydrophilized polyalkylene glycol represented by the following formula (1):

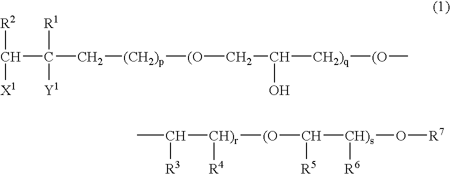

in the formula, X¹ and Y¹ being different from each other, and each representing a hydrogen atom, —SO₃M, —S—CH₂—CH₂—SO₃M, —PO₃M₂, or —S—(CH₂)ₜ—COOM;
R¹ to R⁶ representing a hydrogen atom or an alkyl group;
R⁷ representing a hydrogen atom, an alkyl group, an aryl group, a polyhydric alcohol group, Z¹ or Z² represented by the following formula (2-2) or (2-2);
p, q, r, and s representing a valency;

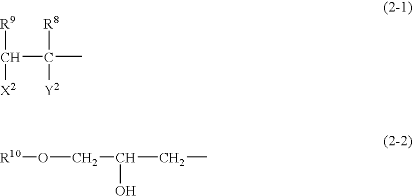

in the formula, X² and Y² being different from each other, and each representing a hydrogen atom, —SO₃M, —S—CH₂—CH₂—SO₃M, —PO₃M₂, or —S—(CH₂)ₜ—COOM;
R⁸ and R⁹ representing a hydrogen atom or an alkyl group; and
R¹⁰ representing an alkyl group or an aryl group.

### TECHNICAL FIELD

The present invention relates to a hydrophilized polyalkylene glycol, a production method thereof, and an application thereof. More preferably, the present invention relates to: a hydrophilized polyalkylene glycol which is preferably used as a builder for cleaning agents, a cleaning agent, a water-treatment agent, and a dispersant, and exhibits high detergency if used as a builder for cleaning agents together with a surfactant; a production method thereof; and, an application thereof.

### BACKGROUND ART

Hydrophilized polyalkylene glycols are compounds having a polyalkylene oxide and a hydrophilic group, and can function as a polymer builder, for example. Such polymers are essential components of liquid cleaning agents because of their property of dissolving into the liquid cleaning agents. A cleaning agent can prevent redeposition of soils removed by cleaning and exhibit high detergency if the cleaning agent contains such a hydrophilized polyalkylene glycol together with a surfactant.

Japanese Kokai Publication No. 2001-158768 (page 2) discloses a method for producing a sulfosuccinic acid monoester by sulfonating a maleic acid monoester obtained by reacting an alkylene oxide adduct of an alcohol with a maleic anhydride, as such a hydrophilized polyalkylene glycol. Japanese Kokai Publication No. Hei-11-349556 (page 2) discloses a sulfosuccinic acid monoester salt of a higher secondary alcohol alkoxylate, which is a mixture containing a sulfosuccinic acid monoester salt of a specific higher secondary alcohol alkoxylate at a specific ratio. These sulfonated polyalkylene glycols are produced by synthesizing polyalkylene glycol-maleic acid ester and sulfonating a double bond part of the maleic acid. Such sulfonated polyalkylene glycols have an ester bond in the molecule. However, hydrolysis easily occurs because of the ester bond under neutral to weak alkaline conditions in which a cleaning agent is preferably used as, for example. Such a glycol has room for improvement in order to be excellent in stability if stored or used under such conditions.

Also Japanese Kokai Publication No. 2002-80888 (pages 2, 5, and 10) discloses an anion surfactant having a polyalkylene glycol which may have a sulfonic acid group. However, all of the production methods described in Examples and descriptions are sulfation methods and a sulfonated method is not clearly specified. There is room for improvement in order to produce a sulfonated polyalkylene glycol.

Further, Japanese Kokai Publication Hei-09-227449 (pages 2 and 5) discloses an anionic compound represented by R¹OCH₂CH₂(OZ)CH₂O(AO)ₘR² (R¹ being a 6 to 22 C straight or branched chain alkyl group or alkenyl group; Z being a carboxyl group, a sulfuric acid ester residue, a propyl sulfonic acid group, or a phosphate group) or a salt thereof. Such a compound has a structure in which an anionic functional group is in the center of the molecule. In such an anionic compound, an anionic surfactant, and a detergent composition, dehydration in an organic solvent is needed in the sulfonation step in the production, and a halogenated carboxylic acid is used in carboxyl group introduction and therefore it is needed that the production step is simplified and possibility of halogen mixing is eliminated. Such a structure has room for improvement in order that such a compound and the like can be preferably applied in various uses by improving various functions.

### SUMMARY OF THE INVENTION

The present invention has been made in view of the above-mentioned state of the art. The present invention has an object to provide: a hydrophilized polyalkylene glycol which is preferably used in applications such as builder for cleaning agents, cleaning agents, water-treatment agents, and dispersants, and can exhibit high basic performances such as detergency; a production method thereof, and an application thereof.

The present inventors have made various investigations about hydrophilized polyalkylene glycols. They have noted that if a hydrophilized polyalkylene glycol has an ester bond in the molecule, hydrolysis easily occurs particularly under alkaline condition. They have found a hydrophilized polyalkylene glycol having no ester bond in the molecule while having a hydrophilic group at the terminal needed for exhibition of basic performances in various applications. They have also found that such a glycol has more improved dispersibility, (micelle formation and the like) or anti-soil redeposition ability, for example, as compared with a compound with a hydrophilic group in the center of the molecule, if having a hydrophilic group at the terminal, and that such a glycol not only has a high stability in storage in an alkali region, but also exhibits detergency higher than that of polyalkylene glycols, particularly in anti-soil redeposition ability to carbon black, and therefore can exhibit effects as a builder for cleaning agents, and the like. They also have found that a sulfonic acid group can be introduced without use of halides such as thionyl chloride, phosphorus trihalide, and hydrogen halide. They have found that according to such a production step, the production step and the equipment can be simplified because dehydrochlorination process and a reactor or a exhauster made of a special material are unnecessary, and that such a production step is excellent in cost performance because possibility of corrosion caused by residual chlorine or strong acid decreases and therefore the production equipment has no need to be made of an expensive material having corrosion resistance. Further, the present inventors have found that residual chlorine in generated hydrophilized polyalkylene glycol is reduced and that fabric wear is reduced when the fabric is washed using the polyalkylene glycol. The above-mentioned problems can be admirably solved. Further, the present inventors have found that such a hydrophilized-polyalkylene glycol can be preferably applied in various uses such as builder for cleaning agents, cleaning agent, water-treatment agents, and dispersants. Thereby, the present invention has been completed.

If a common sulfonating agent is, used, sulfate ester is generated because a terminal of a polyalkylene glycol can not be sulfonated. As a method of sulfonating a polyalkylene glycol, mentioned is a method of preparing an alkyl halide by reaction of a polyalkylene glycol with hydrogen halide, thionyl chloride, or phosphorus trihalide and then reacting Such an alkyl halide with sodium sulfite. However, chlorine may remain in a reaction system and a product in such a method using thionyl chloride. Methods using strong acid-hydrogen halide or phosphorus trihalide having strong toxicity need special production equipment. Therefore, there is room for improvement in order to produce a desired sulfonated polyalkylene glycol using a raw material not containing such as halide.

That is, the present invention is a hydrophilized polyalkylene glycol represented by the following formula (1):

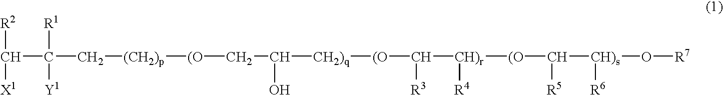

in the formula, X¹ and Y¹ being different from each other, and each representing a hydrogen atom, —SO₃M, —S—CH₂—CH₂—SO₃M, —PO₃M₂, or —S—(CH₂)ₜ—COOM;

M representing a hydrogen atom, an alkali metal atom, an alkali earth metal atom, an ammonium group, or an organic ammonium group;

R¹ and R² being the same or different, and each representing a hydrogen atom or an alkyl group containing 1 to 4 carbon atoms, but not representing a methyl group simultaneously;

R³ and R⁴ being the same or different, and each representing a hydrogen atom or an alkyl group containing 1 to 4 carbon atoms, but not representing an alkyl group simultaneously;

R⁵ and R⁶ being the same or different, and each representing a hydrogen atom or an alkyl group containing 1 to 4 carbon atoms, but not representing an alkyl group simultaneously;

R⁷ representing a hydrogen atom, an alkyl group containing 1 to 14 carbon atoms, an aryl group containing 6 to 10 carbon atoms, a polyhydric alcohol group containing 2 to 8 carbon atoms, Z¹ represented by the following formula (2-1), or Z² represented by the following formula (2-2);

p, q, r, and s each representing a valency;

p being an integer of 0 to 5;

q being 0 or 1;

r+s being an integer of 3 to 100;

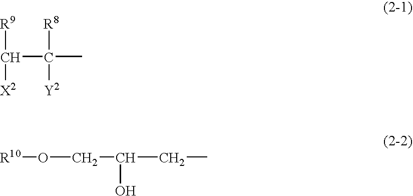

in the formula, X² and Y² being different from each other, and each representing a hydrogen atom, —SO₃M, —S—CH₂—CH₂—SO₃M, —PO₃M₂, or —S— (CH₂)ₜ—COOM;

M representing a hydrogen atom, an alkali metal atom, an alkali earth metal atom, an ammonium group, or an organic ammonium group;

R⁸ and R⁹ being the same or different, and each representing a hydrogen atom or an alkyl group containing 1 to 4 carbon atoms, but not representing a methyl group simultaneously; and

R¹⁰ representing an alkyl group containing 1 to 15 carbon atoms or an aryl group containing 6 to 10 carbon atoms.

### DETAILED DESCRIPTION OF THE INVENTION

The present invention is described in more detail below.

The present invention is a hydrophilized polyalkylene glycol represented by the above formula (1). The above-mentioned hydrophilized polyalkylene glycol has not only high storage stability in alkali regions but also detergency higher than that of polyalkylene glycols and therefore exhibits high anti-soil redeposition ability particularly to carbon black, because of the absence of an ester bond in the molecule. The above-mentioned hydrophilized polyalkylene glycol has a hydrophilic group represented by X¹, or Y¹ (and X² or Y²) and has an anionic group and may contain a derivative having an anionic group.

In the above formula (1), the X¹ and the Y¹ are different from each other and each represent a hydrogen atom, —SO₃M, —S—CH₂—CH₂—SO₃M, —PO₃M₂, or —S—(CH₂)ₜ—COOM. Among them, it is preferable that the X¹ and the Y¹ are different from each other and each represent a hydrogen atom or —SO₃M. The X¹ and the y are different from each other. It is preferable that one is a hydrogen atom and the other is —SO₃M. It is preferable that the X¹ is —SO and the Y¹ is a hydrogen atom.

The above-mentioned alkali metal atom in the M is preferably an alkali metal such as lithium atom, sodium atom, and potassium atom. The above-mentioned alkali earth metal in the M is preferably an alkali earth metal such as calcium and magnesium. Preferred examples of the above-mentioned organic ammonium group (organic amine group) in the M include alkanolamine groups such as ethanolamine group, diethanolamine group, and triethanolamine group, and triethylamine group. The M may be an ammonium group. Among them, the M is preferably a sodium atom.

The R¹ and the R² are the same or different and each represent a hydrogen atom or an alkyl group containing 1 to 4 carbon atoms. However, the R¹ and the R² do not represent a methyl group simultaneously. The following cases are preferred in the R¹ and the R²: the R¹ is a methyl group and the R² is a hydrogen atom; and both of the R⁴ and the R² is a hydrogen atom.

The above-mentioned R¹ to R⁶ are the same or different and each represent a hydrogen atom or an alkyl group containing, 1 to 4 carbon atoms. The R³ and the R⁴ do not represent an alkyl group simultaneously. The R⁵ and the R⁶ do not represent an alkyl group simultaneously. Preferred examples of the alkyl group containing 1 to 4 carbon atoms in the R³ to R⁵ include: straight alkyl groups such as methyl group, ethyl group; propyl group and butyl group; and branched alkyl groups such as isopropyl group and isobutyl group. Each of the above-mentioned R³ to R⁶ is preferably a hydrogen atom, a methyl group, or an ethyl group, and more preferably a hydrogen atom, or a methyl group, and still more preferably a hydrogen atom.

The above-mentioned R⁷ represents a hydrogen atom, an alkyl group containing 1 to 14 carbon atoms, an aryl group containing 6 to 10 carbon atoms, a polyhydric alcohol group containing 2 to 8 carbon atoms, Z¹ (group) represented by the above formula (2-1), or Z² represented by the following formula (2-72). Examples of the alkyl group containing 1 to 14 carbon atoms in the R⁷ include: straight alkyl groups such as methyl group, ethyl group, propyl group, butyl group, pentyl group, hexyl group, heptyl group, octyl group, nonyl group, decyl group, and dodecyl group; and branched alkyl groups such as isopropyl group, isobutyl group, s-butyl group, t-butyl group, and group represented by the following formula (5).

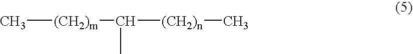

In the formula, m and n each represent an integer, and m+n is 9 to 11.

The above-mentioned alkyl group containing 1 to 14 carbon atoms is preferably a methyl group, an ethyl group, or a group represented by the above formula (5), and still more preferably a methyl group, or a group represented by the above formula (5).

The above-mentioned aryl group containing 6 to 10 carbon atoms in a phenyl group, a naphthyl group, or the like, and more preferably a phenyl group and a naphthyl group, and still more preferably a phenyl group.

Preferred examples of the above-mentioned polyhydric alcohol include polyglycidol, glycerin, polyglycerin, trimethylolethane, trimethylol, propane, 1,3,5-pentatriol, erythritol, pentaerythritol, dipentaerythritol, sorbitol, sorbitan, sorbitol glycerin condensate, adonitol, arabitol, xylitol, and mannitol. Preferred examples of saccharides include hexose saccharides such as glucose, fructose, mannose, indose, sorbose, gulose, talose, tagatose, galactose, allose, psicose, and altrose; pentose saccharides such as arabinose, ribulose, ribose, xylose, xylulose, and lyxose; tetrose saccharides such as threose, erythrulose, and erythrose; other saccharides such as rhamnose, cellobiose, maltose, isomaltose, trehalose, sucrose, raffinose, gentianose, and melezitose; sugar alcohols thereof and sugar acids thereof (saccharides: glucose, sugar alcohol: glucit, sugar acid: gluconic acid).

Further, preferred are derivatives of these mentioned compounds such as partial ether compound thereof and partial esterified compound thereof. Among them, sorbitol is more preferred.

In the above-mentioned Z¹ represented by the above formula (2-1), the X² and the Y² are different from each other and each represent a hydrogen atom, —SO, —S—CH₂—CH₂—SO₃M, —PO₃M₂, or —S—(CH₂)ₜ—COOM. Among them, it is preferable that the X² and the Y² are different from each other and each represent a hydrogen atom or —SO₃M. It is preferable that the X² and the Y² are different from each other and one is a hydrogen atom and the other is —SO₃M. It is preferable that the X² is —SO₃M and the Y² is a hydrogen atom. The M represents a hydrogen atom, an alkali metal atom, an alkaline earth metal atom, an ammonium group, or an organic ammonium group.

The R⁸ and the R⁹ are the same or different and each represent a hydrogen atom or an alkyl group containing 1 to 4 carbon atoms. However, the R⁸ and the R⁹ do not represent a methyl group simultaneously. The following cases are preferable in the R⁸ and the R⁹: the R⁸ is a methyl group and the R⁹ is a hydrogen atom; and both of the R⁸ and the R⁹ is a hydrogen atom.

The above-mentioned p is preferably 0 to 5′, and more preferably 0 or 1.

The above-mentioned q is preferably 0 or 1.

In the Z² represented by the above formula (2-2), R¹⁰ represents an alkyl group containing 1 to 15 carbon atoms or an aryl group containing 6 to 10 carbon atoms. Examples of the alkyl group containing 1 to 15 carbon atoms in R¹⁰ include straight alkyl groups such as methyl group, ethyl group, propyl group, butyl group, pentyl group, hexyl group, heptyl group, octyl group, nonyl group, decyl group, dodecyl group, tridecyl group, tetradecyl group, and pentadecyl group; and branched alkyl groups such as isopropyl group, isobutyl group, s-butyl group, t-butyl group, 2-ethylhexyl group, and a group represented by the above formula (5) .

Preferred examples of the aryl group containing 6 to 10 carbon atoms in R¹⁰ are the same as in the above-mentioned aryl group containing 6 to 10 carbon atoms in the R⁷.

The above-mentioned r and s each represent an average molar number of addition of an oxyalkylene group. The molar number of addition is generally distributed. That is, the average molar number of addition in the hydrophilized polyalkylene glycol, that is, r+s is 3 to 100. Under water, the above-mentioned oxyalkylene group exhibits effect of adsorbing contaminants such as carbon black, and the hydrophilic group provides the hydrophilized polyalkylene glycol with dispersibility. If the r+s is within such a range, functional effects attributed to the oxyalkylene group and the hydrophilic group can be sufficiently exhibited. The average molar number of addition is preferably 4 to 100, and more preferably 5 to 80, and still more preferably 8 to 60. The hydrophilized polyalkylene glycol can be easily handled if the average molar number of addition is 60 or less. The average molar number of addition is an average value of the molar number of the oxyalkylene group adding to 1 mol of the hydrophilized polyalkylene glycol. Each unit of the —O—CH(R³)—CH(R⁴) and the —O—CH(R⁵)—CH(R⁶) may be bonded alternatively, randomly, or in block. Any unit may bond to the (—O—CH₂—CH(OH)—CH₂—). If the r is 2 or more, the R³ and the R⁴ may be different from each other. If the s is 2 or more, the R⁵ and the R⁶ may be different from each other.

It is preferable that the above-mentioned hydrophilized polyalkylene glycol is a sulfonated polyalkylene glycol in which the X¹ and the Y¹ in the above formula (1) are different from each other and each represent a hydrogen, atom or —SO₃M, and the X² and the Y² in the above formula (2-1) are different from each other and each represents a hydrogen atom or —SO₃M. As mentioned above, preferable embodiments of the present invention include the sulfonated polyalkylene glycol represented by the above formula (1) (the X¹ and the Y¹ in the above formula (1) being different from each other and each representing a hydrogen atom or —SO₃M; and the X² and the Y² in the above formula (2-1) being different from each other and each representing a hydrogen atom or —SO₃M.).

The above-mentioned hydrophilized polyalkylene glycol preferably has any of the following embodiments: (1) an embodiment in which the R¹ represents a methyl group, the R² represents a hydrogen atom, the p is 1, and the q is 0; (2) an embodiment in which each of the R¹ and the R² represents a hydrogen atom, and each of the p and the q is 0; (3) an embodiment in which each of the R¹ and the R² represents a hydrogen atom, the p is 0, and the q is 1.

In the above embodiments, the hydrophilized polyalkylene glycol having the embodiment (1) has a skeleton derived from isoprenol; the glycol having the embodiment (2) has a skeleton derived from allyl alcohol; and the glycol having the embodiment (3) has a skeleton derived from allyl glycidyl ether. Such embodiments have advantages such as easy hydrophilization step because of little steric hindrance around the double bond.

The following embodiments are more preferable in the above-mentioned embodiments (1) to (3): (4) an embodiment in which the s is 0; and each of the R³, the R⁴, and the R⁷ represents a hydrogen atom in the embodiment (1) or (2) (5) an embodiment in which the s is 0; each of the R³ and the R⁴ represents a hydrogen atom; and the R⁷ represents an alkyl group containing 1 to 14 carbon atoms (straight or branched alkyl group) or a polyhydric alcohol group containing 2 to 8 carbon atoms; and (6) an embodiment in which the s is 0, each of the R³ and the R⁴ represents a hydrogen atom; and the R⁷ represents the Z² in the embodiment (1) or (2).

The above-mentioned embodiments (4) to (6) have advantage of high water solubility because each of the R³ to the R⁶ is a hydrogen atom, and the alkylene glycol chain is a polyethylene glycol.

In the above-mentioned embodiments (4) to (6), a preferable range of the r+s is as mentioned above. In the embodiment (4), the r+s is particularly preferably 10, 25, or 50. In the embodiment (5), the r+s is particularly preferably 10, 20, or 50.

As mentioned above, it is preferable that the hydrophilized polyalkylene glycol of the present invention is a sulfonated polyalkylene glycol having a sulfonic acid (salt) group. It is more preferred that the sulfonated polyalkylene glycol has one embodiment of the above-mentioned (1) to (5). The term “sulfonic acid (salt) group” means that the sulfonic acid group may be an acid type or a salt type. Part of or all of the above-mentioned sulfonic acid group in the sulfonated polyalkylene glycol may be salts.

The hydrophilized polyalkylene glycol of the present invention exhibits various functions and has particularly excellent anti-soil redeposition ability because the hydrophilized polyalkylene glycol has a polyalkylene oxide and a hydrophilic group. The anti-soil redeposition ability depends on hardness of an aqueous solution to be used. The hydrophilized polyalkylene glycol preferably satisfies the following conditions: (I) anti-soil redeposition ability of 80% or more in an aqueous solution with a CaCO₃ concentration of 50 ppm (low hardness); or (II) anti-soil redeposition ability of 40% or more in an aqueous solution with a CaCO₃ concentration of 200 ppm (high hardness). If linear alkylbenzene sulfonate (LAS), alkyl sulfate (AS), and the like, which is used as a widely used surfactant, is used under high hardness conditions, the surfactant concentration is substantially reduced under high hardness conditions because such a widely used surfactant and hardness components, such as calcium ion and magnesium ion forms salts and then deposits and precipitates. This is considered as one of causes for reduction in anti-soil redeposition ability according to hardness conditions.

As mentioned above, the preferable embodiments of the present invention include the embodiment (I) in which the hydrophilized polyalkylene glycol has an anti-soil redeposition ability of 80% or more in an aqueous solution with a CaCO₃ concentration of 50 ppm; and the embodiment (II in which the hydrophilized polyalkylene glycol has an anti-soil redeposition ability of 40% or more in an aqueous solution with a CaCO₃ concentration of 200 ppm.

The anti-soil redeposition ability can be measured according to anti-soil redeposition ability evaluation test mentioned below.

The hydrophilized polyalkylene glycol whitens a white cloth as an evaluation object enough and sufficiently functions as a builder for cleaning agents if having an anti-soil redeposition ability of 80% or more in the embodiment (I). A preferable range of the anti-soil redeposition ratio under low hardness conditions is 83% or more and more preferably 85% or more.

If the hydrophilized polyalkylene glycol has an anti-soil redeposition ability of 40% or more in the embodiment (II), the anti-soil redeposition ability is insufficient because contaminants (carbon black in anti-soil redeposition ability, evaluation test mentioned below) adhere as aggregate to a white cloth as an evaluation object in a spotty fashion. A preferable range of the anti-soil redeposition ratio under high-hardness conditions is 45% or more and more preferably 50% or more.

The present invention is also a sulfonated polyalkylene glycol comprising a polyalkylene oxide and a sulfonic acid (salt), group, wherein the sulfonated polyalkylene glycol has an anti-soil redeposition ability of 40% or more in an aqueous solution with a CaCO₃ concentration of 200 ppm and contains no ester bond. A preferable, range of the anti-soil redeposition ability of such a sulfonated polyalkylene glycol is as mentioned above.

The above-mentioned sulfonated polyalkylene glycol contains no ester bond in the molecule, and therefore hardly causes hydrolysis under neutral to weak alkaline conditions in which a cleaning agent is preferably used. Therefore, such a sulfonated polyalkylene glycol is excellent in stability if 200 stored and used under such conditions.

The present invention is also a production method of a hydrophilized polyalkylene glycol, the method comprising a step of hydrophilizing a double bond of a polyalkyleneglycol with the double bond, wherein the step is performed using a raw material containing no halide.

The above-mentioned hydrophilization step is not especially limited as long as the hydrophilized polyalkylene glycol is produced using a raw material containing no halide. For example, a polyalkylene glycol with a double bond and a hydrophilization agent substantially containing no halide are reacted as they are or in the presence of a radical source or oxygen. Among them, it is preferable that the reaction is preferably performed in the presence of a radial source or oxygen. The raw material containing no halide means the raw material substantially containing no halide. The raw material containing no halide means one containing a halide of 1000 ppm or less. The content of the halide is preferably 500 ppm and more preferably 100 ppm or less.

Preferred examples of the above-mentioned hydrophilization agent substantially containing no halide include: hydrogen sulfites such as ammonium hydrogensulfite, potassium hydrogensulfite, and sodium hydrogen sulfite, sulfites such as ammonium sulfite, potassium sulfite, and sodium sulfite; disulfite such as potassium disulfite and sodium disulfite; mercapto isethionic acid, phosphites (ammonium salt, potassium salt, sodium salt), phosphinates (ammonium salt, potassium salt, sodium salt), mercaptopropionic acid, and mercaptoacetic acid. One or two or more species of them is/are preferably used. Among them, more preferred are sulfonation agents, for example, hydrogen sulfites such as ammonium hydrogensulfite, potassium hydrogensulfite, and sodium hydrogensulfite; sulfites such as ammonium sulfite, potassium sulfite, and sodium sulfite; and disulfites such as potassium disulfite and sodium disulfite. As mentioned above, it is preferable that the sulfonated polyalkylene glycol is produced using a sulfonation agent substantially containing no halide. The preferable embodiments of the present invention include a production method of a sulfonated polyalkylene glycol, comprising a step of sulfonating a double bond of a polyalkylene glycol with the double bond, wherein the step is performed using a raw material substantially containing no halide. The above-mentioned sulfonation agent is preferably sodium hydrogensulfite and sodium sulfite, and more preferably sodium hydrogensulfite.

The above-mentioned hydrophilization agent may contain a halide of 500 ppm or less, preferably 100 ppm or less as impurities as long as it substantially contains no halide.

The preferable embodiment in the above-mentioned hydrophilization step is an embodiment in which hydrogensulfite and/or sulfite are/is reacted in the presence of a radical source or oxygen.

Reaction conditions of the above-mentioned hydrophilization step may be appropriately determined depending on a compound used in the reaction, a terminal structure of a desired hydrophilized polyalkylene glycol. The reaction temperature is preferably 0 to 200° C., for example. The reaction temperature is more preferably 5° C. or more and 150° C. or less, and still more preferably 10° C. or more and 120° C. or less, and particularly preferably 15° C. or more and 100° C. or less, and most preferably 20° C. or more and 80° C. or less. The reaction time is preferably 1 to 100 hours, and more preferably 2 hours or more and 50 hours or less, and still more preferably 3 hours or more and 30 hours or less, and most preferably 4 hours or more and 25 hours or less.

In the above-mentioned-hydrophilization step, it is preferable that the molar ratio of a polyalkylene glycol to be; used in the reaction to the hydrophilization agent is 1:1 to 1:30. The above-mentioned molar ratio is more preferably 1:1 to 1:20, and still more preferably 1:1 to 1:15, and particularly preferably 1:1 to 1:10, and most preferably 1:1 to 1:8.

The above-mentioned hydrophilization step may be performed under air atmosphere or inert gas atmosphere, and preferably under air atmosphere.

In the above-mentioned hydrophilization step, for example, a polyalkylene glycol having a terminal structure of an alkenyl is charged into a reactor, and thereinto the hydrophilization agent may be added in one portion, or successively and preferably added successively. Persulfates are preferably used as the radical source if the radical source is used. The molar ratio of the hydrophilization agent to the radical generator is preferably 1:0.01 to 1:5, and more preferably 1:0.1 to 1:2, and still more preferably 1:0.2 to 1:1. The radical generator may be added in one portion or successively added, and preferably added successively. If the hydrophilization reaction is performed in the presence of oxygen, air or oxygen may be bubbled, or the reaction is performed just under air atmosphere. Aqueous solvents such as water, alcohol, glycol, glycerin, and polyethylene glycol are preferred as a solvent. Water is particularly preferable. These may be singly or in combination of two or more species of them. The pH of the reaction solution at 25° C. is preferably 6, to 10, and more preferably 7 to 9. The pH of less than 6 is not preferable because toxic sulfurous acid gas is generated and effective addition can not be performed any more. The pH of more than 10 is not preferable in terms of safety. The reaction temperature is preferably 10 to 60° C. and more preferably 20 to 40° C. The concentration of the reaction solution is preferably 20 to 60% by weight, and more, preferably 0.30 to 50% by weight, and still more preferably 35 to 45% by weight. The concentration of the reaction solution of more than 60% by weight is not preferable, because concentration of oxygen remaining in the solution is reduced and therefore it takes time to perform the reaction. The concentration of less than 20% by weight is not preferable in view of productivity.

If the polyalkylene glycol with a double bond of the present invention has an ester bond, the double bond needs to be contained at least on the polyalkylene glycol side. The double bond may or may not be contained on the carboxylic acid side. For example, an acetate of an alkyl alcohol-ethyleneoxide adductor a acrylic ester of an isoprenol-ethylene oxide adduct is included, but an acrylic ester of poly(ethylene glycol)methyl ether or a maleate of polyethylene glycol is not included.

The above-mentioned production method is preferably the production method of the hydrophilized polyalkylene glycol,

wherein the hydrophilized polyalkylene glycol is represented by the following formula (1), and the hydrophilized polyalkylene glycol is produced by hydrophilizing a double bond of a polyalkylene glycol with the double bond represented by the following formula (3):

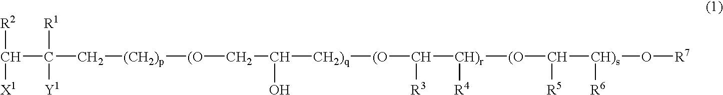

in the formula, X¹ and Y¹ being different from each other, and each representing a hydrogen atom, —SO₃M, —S—CH₂—CH₂—SO₃M, —PO₃M₂, or, —S—(CH₂)ₜ—COOM;

M representing a hydrogen atom, an alkali metal atom, an alkali earth metal atom, an ammonium group or an organic ammonium group;

R¹ and R² being the same or different from each other, and each representing a hydrogen atom or an alkyl group containing 1 to 4, but not representing a methyl group simultaneously;

R³ and R⁴ being the same or different, and each representing a hydrogen atom or an alkyl group containing 1 to 4 carbon atoms, but not representing an alkyl group;

R⁵ and R⁶ being the same or different, and each representing a hydrogen atom or an alkyl group containing 1 to 4 carbon atoms, but not representing an alkyl group;

R⁷ representing a hydrogen atom, an alkyl group containing 1 to 14 carbon atoms, an aryl group containing 6 to 10 carbon atoms, a polyhydric alcohol group containing 2 to 8 Carbon atoms, Z¹ represented by the following formula (2-1), or Z² represented by the following formula (2-2);

p, q, r, and s each representing a valency;

p being an integer of 0 to 5;

q being 0 or 1;

r+s being an integer of 3 to 100;

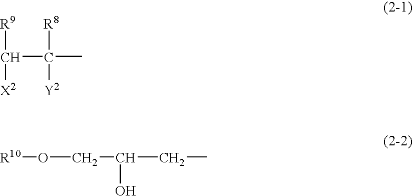

in the formula, X² and Y² being different from each other; and each representing a hydrogen atom, —SO₃M, —S—CH₂—CH₂SO₃M, PO₃M₂, or —S— (CH₂)ₜ—COOM;

M representing a hydrogen atom; an alkali metal atom, an alkali earth metal atom, an ammonium group, or an organic ammonium group;

R⁸ and R⁹, being the same or different, and each representing a hydrogen atom or an alkyl group containing 1 to 4 carbon atoms, but not representing a methyl group simultaneously;

R¹⁰ representing an alkyl group containing 1 to 15 carbon atoms or an aryl group containing 6 to 10 carbon atoms,

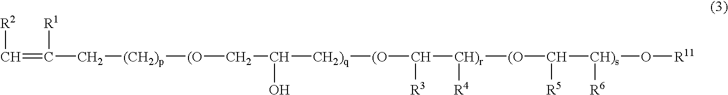

in the formula, R¹, R, R³, R⁴, R⁵, and R⁶ are the same as those in, the above formula (1), respectively;

R¹¹ representing a hydrogen atom, an alkyl group containing 1 to 14-carbon atoms, an aryl group containing 6 to 10 carbon atoms, a polyhydric alcohol group containing 2 to 8 carbon atoms, or Z³ represented by the following formula (4), or the Z² represented by the above formula (2-2);

p, q, r and s being the same as those in the above formula (1), respectively,

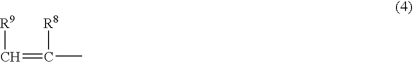

in the formula, R⁸ and R⁹ being the same as those in the above formula (2-1), respectively.

In the above-mentioned production method, it is preferable that the hydrophilized polyalkylene glycol is a sulfonated polyalkylene glycol n which the X¹ and the Y¹ in the above formula (1) are different from each other and each represent a hydrogen atom, —SO₃M, and the X² and the Y² in the above formula (2-1) are different from each other and each represent, a hydrogen atom or —SO₃M. As mentioned above, the preferable embodiments of the present invention include the production method of the sulfonated polyalkylene glycol, wherein the sulfonated polyalkylene glycol is represented by the above formula (1) and the sulfonated polyalkylene glycol is produced by sulfonating a double bond of a polyalkylene glycol with the double bond represented by the following formula (3) (the X¹ and the Y¹ in the above formula (1) being different from each other and each, representing a hydrogen atom or —SO₃M; and the X² and the Y² in the above formula (2-1) being different from each other and each representing a hydrogen atom or —SO₃M.

In the above-mentioned-hydrophilization step, the hydrophilization agent is used for the reaction if the polyalkylene glycol with a double bond has a terminal structure of an alkenyl group, as represented by the above formula (3). Preferred examples of the polyalkylene glycol having a terminal structure of an alkenyl group include the following compounds represented by the following formulae (6) to (8) having skeletons derived from isoprenol, allyl alcohol, and alkylglycidyl ether, respectively.

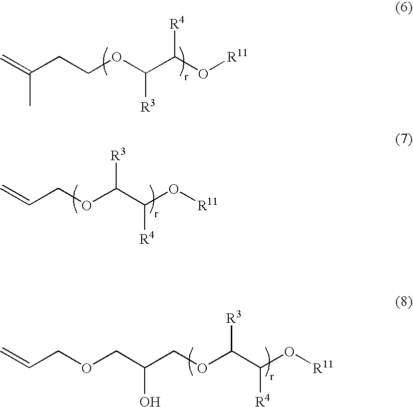

in the above formulae (6) to (8), R³, R⁴, R¹¹, and r are the same as those in the above-mentioned formula (3), respectively.

More preferable examples of the above-mentioned polyalkylene glycol having a terminal structure of an alkenyl group include an isoprenol ethylene oxide adduct represented by the following formula (9) in which each of the R³, the R⁴, and the R¹¹ in the above formula (6) is a hydrogen atom; and an allyl alcohol-ethylene oxide adduct represented by the following formula (10) in which each of the R³, the R⁴, and the R¹¹ in the above formula (7) is a hydrogen atom; and a compound represented by the following formula (11) in which each of the R³ and the R⁴ in the above formula (8) is a hydrogen atom, and the R¹¹ is an alkyl group containing 1 to 14 carbon atoms (straight or branched alkyl group) or a polyhydric alcohol containing 2 to 8 carbon atoms.

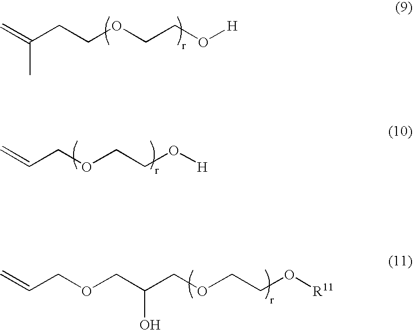

A compound represented by the following formula (12), in which the R¹¹ is the above formula (2-2) in the above-mentioned (31), is also preferable as the above-mentioned polyalkylene glycol having a terminal structure of an alkenyl group. The R¹⁰ is the R¹¹, in the above formula (2-2).

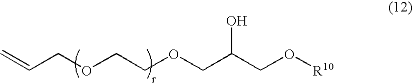

The isoprenol-ethylene oxide adduct represented by the above formula (9) is preferably an isoprenol-ethylene oxide 10 mol adduct, an isoprenol-ethylene oxide 50 mol adduct, or the like. Among them, an isoprenol-ethylene oxide 10 mol adduct and an isoprenol-ethylene oxide 50 mol adduct are preferable, and an isoprenol-ethylene oxide 50 mol adduct is more preferable.

The allyl alcohol-ethylene oxide adduct represented by the above formula (10) is preferably an allyl alcohol-ethylene oxide 5 mol adduct, an allyl alcohol-ethyleneoxide 10 mol adduct, an allyl alcohol-ethylene oxide 15 mol adduct, an allyl alcohol-ethylene oxide 25 mol adduct, an allyl alcohol-ethylene oxide 3 mol adduct, an allyl alcohol-ethylene oxide 50 mol adduct, or the like. Among them, preferred are an allyl alcohol-ethylene oxide 5 mol adduct, an allyl alcohol-ethylene oxide 10 mol adduct, and an allyl alcohol-ethylene oxide 25 mol adduct.

The compound represented by the above formula (11) can be produced by reacting a polyalkylene glycol with allyl glycidyl ether (AGE), as shown in the following reaction formula (1). As mentioned above, a polyalkyleneglycol not containing a double bond can be hydrophilized by hydrophilizing a double bond derived from AGE in the compound represented by the above formula (11) with sodium hydrogensulfite (SBS).

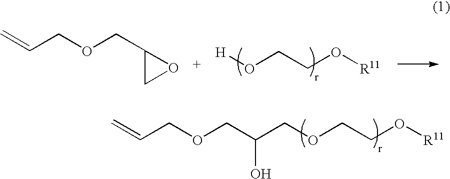

Preferred examples of the compound represented by the above formula (11) include: a reactant of poly (ethylene glycol) methyl ether in which the R¹¹ is a methyl group with allyl glycidyl ether; a reactant of SOFTANOL (registered trademark) in which the R¹¹ is an alkyl group containing 12 to 14 carbon atoms represented by the above formula (5) with allyl glycidyl, ether; a reactant of poly (ethylene glycol) phenyl ether in which the R¹¹ is a benzyl group with allyl glycidyl ether; and a reactant of a sorbitol-ethylene oxide adduct in which an alcohol part in the R¹¹ is sorbitol with allyl glycidyl ether.

The compound represented by the above formula, (12) is preferably produced by reacting a PEG chain having a double bond with an alkyl(aryl)glycidyl ether, as shown in the following formula.

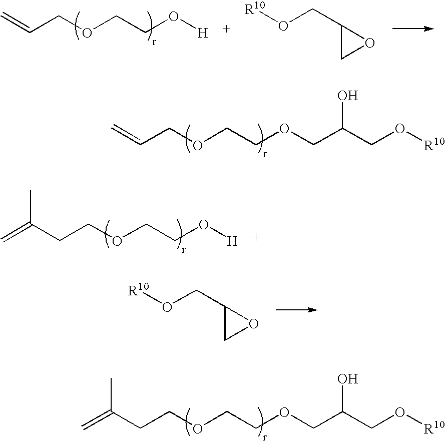

The above-mentioned production method needs no special exhauster and the like because a halide having strong toxicity such as phosphorus trihalide is not used in the hydrophilization of the polyalkylene glycol. Therefore, the production equipment can be simplified. Also, the production method needs no dehydrochlorination process because a chloride such as thionyl chloride is not used. Therefore, the production equipment can be simplified. The production method uses neither chlorides such as thionyl chloride nor strong acid hydrogen halide, and therefore, corrosion during the production process such as in a reaction pot may not be generated. Therefore, the quality of the material of the production equipment is not limited to high-class materials such as glass lining and Teflon (registered trademark) and SUS and the like can be preferably used. Further, maintenance of the production equipment can be easily performed. The obtained hydrophilized polyalkylene glycol substantially contains no residual chlorine. Therefore, no fabric wear is caused by chlorine at the time of cleaning if the glycol is used as a cleaning agent. Accordingly, the above-mentioned production-method permits sufficient reduction in halide concentration of the obtained polyalkylene glycol and the reaction solution during the production step. Therefore, the halide concentration in the end product and/or in the reaction solution in the entire production steps can be 10 ppm or less.

As mentioned above, (1) the preferable embodiments of the present invention include the hydrophilized polyalkylene glycol having a halide concentration of 10 ppm or less; and (2) a production method of the hydrophilized polyalkylene glycol, wherein the polymerization solution in the entire production steps has a halide concentration of 10 ppm or less. The above-mentioned production method of the hydrophilized polyalkylene glycol having a halide concentration of 10 ppm or less is not especially limited. Such a hydrophilized polyalkylene glycol may be produced by the above-mentioned production method or by another production method.

The hydrophilized polyalkylene glycol of the present invention can be produced by the above-mentioned production method. Such a hydrophilized polyalkylene glycol produced by the above-mentioned production method is also one of the preferable embodiments of the present invention.

The present invention is also a detergent composition, a water-treatment agent, or a dispersant, comprising the hydrophilized polyalkylene glycol of the present invention.

The above-mentioned hydrophilized polyalkylene glycol may be a hydrophilized polyalkylene glycol produced by the production method of the present invention, or may be produced by another production method. The above-mentioned detergent composition means additives for detergents, detergents, builders for cleaning agents (cleaning agent builders), or cleaning agents.

The above-mentioned builders for cleaning agents exhibit functions for preventing redeposition of soil to clothes and the like during cleaning. If the hydrophilized polyalkylene glycol prevents redeposition of soil, it is preferable that either of the following functions is sufficiently exhibited, in addition to a function attributed to the steric structure of the polyalkyleneoxide chain: a function of reducing affinity with soils; if the glycol has a hydrophobic terminal structure; or a function of dispersing soil if the glycol has a hydrophilic terminal structure.

The above-mentioned builder for cleaning agents is excellent incompatibility with surfactants and a cleaning agent obtained by using such a builder for cleaning agents be comes a high-concentrated liquid cleaning agent. Therefore, such a builder for cleaning agent can be preferably used as a builder for liquid cleaning agents. The liquid cleaning agent obtained by using the builder for cleaning agents has excellent transparency because of the excellent compatibility with surfactants. Therefore, separation in the liquid cleaning agent, which is caused by turbidity, can be prevented. Also, the builder for cleaning agents can form a high-concentrated liquid cleaning agent because of the excellent compatibility. Therefore, detergency of the liquid cleaning agent can be improved.

The above-mentioned cleaning agent builder can be a cleaning agent builder which is excellent in anti-soil redeposition ability; hardly causes reduction in performances if stored for a prolonged period or impurity deposition if maintained at low temperatures, therefore having agent performances with extremely high quality and excellent stability.

Composition components other than the hydrophilized polyalkylene glycol and the mixing ratio thereof in the above-mentioned cleaning agent builder can be appropriately determined based on various components used for common cleaning agent builders and the mixing, ratio thereof, unless effects of the present invention are sacrificed.

The above-mentioned cleaning agent may be a powder cleaning agent or a liquid cleaning agent, and preferably a liquid cleaning agent because the hydrophilized polyalkylene-glycol has excellent solubility in liquid cleaning agents. The above-mentioned cleaning agent may contain additives generally used in cleaning agents, in addition to the hydrophilized polyalkylene glycol. Preferred examples of the above-mentioned additives include: surfactants; redeposition inhibitors for preventing redeposition of contaminants, such as alkali builders, chelate builders, polycarboxylates such as polyacrylate and polyacrylate-maleate-copolymer, and sodium carboxymethylcellulose; soil inhibitors such as benzotriazol and ethylene-thiourea; soil release agents, color transfer inhibitors, softening agents, alkaline substances for pH control, perfumes, solubilizing agents, fluorescence agents, coloring agents, foaming agents foam stabilizers, lustering agents, fungicides, bleaching agents, bleaching assistants, enzymes, dyes, and solvents. It is preferable that the cleaning agent may contain zeolite if the cleaning agent is a powder cleaning agent.

The hydrophilized polyalkylene glycol is added such that the glycol is preferably 0.1 to 20% by weight relative to 100% by weight of the cleaning agent, and more preferably 0.2 to 10% by weight, and still more preferably 0.3 to 5% by weight, and particularly preferably 0.4 to 4% by weight if used in the above-mentioned cleaning agent. If the glycol is less than 0.1% by weight, detergency of the cleaning agent may be insufficient.

If the glycol is more than 20% by weight, the economic efficiency may be reduced.

The mixing form of the hydrophilized polyalkylene glycol in the above-mentioned cleaning agent may be in liquid form or in solid form and can be determined depending on the form of the cleaning agent at the time of delivery (for example, liquid, substance or solid substance). The hydrophilized polyalkylene glycol may be mixed in form of an aqueous solution after polymerization, may be mixed in form of a concentrated aqueous solution prepared by removing moisture from the aqueous solution to some extent, or may be mixed after dried and solidified.

The above-mentioned cleaning agent includes cleaning agents used for only a specific application such as bleach agents in which one function in the component is improved, in addition to synthetic cleaning agents such as household cleaning agents, cleaning agents for industrial use such as fiber industry and hard surface detergents.

The above-mentioned surfactant is at least one species selected from anionic surfactants, nonionic surfactants, cationic surfactants, and amphoteric surfactants. One or two or more species of these surfactants may be used. If two or more species of them are used, a total use amount of the anionic surfactant and the nonionic surfactant is preferably 50% by weight or more, relative to 100% by weight of a total amount of the surfactant, and more preferably 60% by weight or more, and still more preferably 70% by weight or more, and particularly preferably 80% by weight or more.

Examples of the above-mentioned anionic surfactants include alkylbenzene sulfonates, alkyl ether sulfates, alkenyl ether sulfates, alkyl sulfates, alkenyl sulfates, α-olefin sulfonates, α-sulfofatty acids or ester salts thereof, alkane sulfonates, saturated fatty acid salts, unsaturated fatty acid salts, alkyl ether carboxylates, alkenyl ether carboxylates, amino acid surfactants, N-acylamino acid surfactants, and, alkyl phosphate or salts thereof, and alkenyl phosphate or salts thereof.

The alkyl group or the alkenyl group of the above-mentioned anionic surfactant may have a branched structure of the alkyl group such as a methyl group.

Examples of the above-mentioned nonionic surfactants include polyoxyalkylene alkyl ethers, polyoxyalkylene alkenyl ethers, polyoxyethylene alkyl phenyl ethers, higher fatty acid alkanol amides or alkylene oxide adducts thereof, sucrose fatty acid esters, alkyl glycoxides, fatty acid glycerin monoesters, and alkylamine oxides. The alkyl group or the alkenyl group of the above-mentioned nonionic, surfactants may have a branched structure of the alkyl group such as a methyl group.

Quaternary ammonium salts and the like are preferred as the above-mentioned cationic surfactants. Carboxyl type or sulfobetaine type amphoteric surfactants are preferred as the above-mentioned amphoteric surfactants.

The alkyl group or the alkenyl group, of the above-mentioned cationic surfactants and the above mentioned amphoteric surfactants may have a branched structure of the alkyl group such as a methyl group.

The mixing ratio of the above-mentioned surfactant is generally preferably 10 to 60% by weight, relative to 100% by weight of the liquid cleaning agent, and more preferably 15% by weight or more and 50% by weight or less, and still more preferably 20% by weight or more and 45% by weight or less, and particularly preferably 25% by weight or more and 40% by weight or less. If the mixing ratio of the surfactant is less than 10% by weight, the cleaning agent may exhibit insufficient detergency. If the mixing ratio thereof is more than 60% by weight, the economic efficiency may be reduced.

The mixing ratio of the above-mentioned builder for liquid cleaning agents is generally preferably 0.1 to 20% by weight, relative to 100% by weight of the liquid cleaning agent, and more preferably 0.2% by weight or more and 15% by weight or less, and still more preferably 0.3% by weight or more and 10% by weight or less, and still more preferably 0.4% by weight or more and 8% by weight or less, and particularly preferably 0.5% by weight or more and 5% by weight or less. If the mixing ratio of the builder for liquid cleaning agents is less than 0.1% by weight, the cleaning agent may exhibit insufficient performances. If the mixing-ratio thereof is more than 20% by weight, the economic efficiency may be reduced.

The moisture content in the above-mentioned liquid cleaning agent is generally preferably 0.1 to 75% by weight, relative to 100% by weight of the liquid cleaning agent, and more preferably 0.2% by weight or more and 70% by weight or less, and still more preferably 0.5% by weight or more and 65% by weight or less, and still more preferably 0.7% by weight or more and 60% by weight or less, and still more preferably 1,% by weight or more and 55%; by weight or less, and most preferably 1.5% by weight or more and 50% by weight or less.

The above-mentioned liquid cleaning agent preferably has a kaolin turbidity of 200 mg/L or less, and more preferably 150 mg/L or less, and still more preferably 120 mg/L or less, and particularly preferably 100 mg/L or less, and most preferably, 50 mg/L or less.

Change (difference) in the kaolin turbidity between the case where the hydrophilized polyalkylene glycol of the present invention is added in the liquid cleaning agent and the case where the glycol is not added is preferably 500 mg/L or less.

The difference is more preferably 400 mg/L or less, and still more preferably 300 mg/L or less, and particularly preferably 200 mg/L or less, and most preferably 100 mg/L or less. The kaolin turbidity can be determined by the following method, for example.

### (Measurement Method of Kaolin Turbidity).

Into a 50 mm square cell in 10 mm thickness is charged a uniformly stirred sample (liquid cleaning agent), and bubbles are removed therefrom. Then, the sample is measured for turbidity (kaolin turbidity: mg/L) at 25° C. using NDH2000 (trade name, turbidimeter) produced by Nippon Denshoku Industries Co., Ltd.

Examples of the enzyme which can be mixed in the cleaning agent of the present invention include proteases, lipases, and cellulases. Among them, proteases alkali lipases, and alkali cellulases are preferable because they show high activity in alkali cleaning solutions.

The addition amount of the above-mentioned enzyme is preferably 5% by weight or less, relative to 100% by weight of the cleaning agent. If the addition amount thereof is more than 5% by weight, the detergency is not improved anymore, resulting in economic inefficiency.

Preferred examples of the above-mentioned alkali builder include silicates, carbonates, and sulfates. Preferred examples of the above-mentioned chelate builder include diglycolic acid, hydroxy acid salt, EDTA (ethylenediaminetetraacetic acid), DTPA (diethylenetriamine tetraacetic acid), and citric acid. Water-soluble polycarboxylic acid polymers also may be used.

The above-mentioned cleaning agent can be a cleaning agent which is excellent in dispersibility and hardly causes reduction in performances if stored for a prolonged period or impurity deposition if maintained at low temperatures, and therefore has agent performances with extremely high quality and excellent stability.

The above-mentioned water-treatment agent may be added in a water system such as a cooling water system and a boiler water system, for example. In this case, the hydrophilized polyalkylene glycol may be added as it is, or a water-treatment agent containing another component in addition to the hydrophilized polyalkylene glycol may be added.

Composition components other than the hydrophilized polyalkylene glycol and the mixing ratio thereof in the above-mentioned water-treatment agent can be appropriately adopted based on various components used for common water-treatment agents and the mixing ratio thereof, unless effects of the present invention are sacrificed.

The above-mentioned dispersant is an aqueous dispersant.

For example, pigment agents, cement dispersants, dispersants of calcium carbonate, dispersants of kaolin are preferred.

The above-mentioned dispersant can exhibit extremely excellent dispersibility which the hydrophilized polyalkylene glycol originally has. Also, the dispersant can be a dispersant which hardly causes reduction in performances if stored for a prolonged period or impurity deposition if maintained at low temperatures and therefore has agent performances with extremely high quality and excellent, stability.

Composition components other than the hydrophilized polyalkylene glycol and the mixing ratio in the above-mentioned dispersant can be appropriately adopted based on various components used for common dispersant and the mixing ratio, unless effects of the present invention are sacrificed.

The hydrophilized polyalkylene glycol of the present invention can be preferably used in applications such as builders for cleaning agents, cleaning agents, water-treatment agents, and dispersants. Also in other applications in which the hydrophilized polyalkylene glycol is used, various properties which this copolymer exhibits are improved and therefore the glycol can be preferably used.

The hydrophilized polyalkylene glycol of the present invention has the above-mentioned excellent properties, and preferably has an anti-soil redeposition ability determined by the following method of 80% or more, and more preferably 82% or more. The hydrophilized polyalkylene glycol can exhibit excellent performances as a detergent composition if having an anti-soil redeposition ability within such a range.

### (Evaluation Test of Anti-Soil Redeposition Ability)

(1) A polyester jersey obtained from test fabrics, Inc. is cut into 2 cm×2 cm to prepare white clothes. Whiteness of each of the white clothes is previously measured as reflectance using colorimetry color difference meter SE2000 type produced by Nippon Denshoku Industries Co., Ltd.
(2) Pure water is added to calcium chloride dihydrate 0.368 g to prepare hard water 5000 g. Then, this hard water is charged into an incubator at, 25° C.
(3) Carbon black 0.5 g obtained from Cleaning Science Association Foundation and the hard water 500 mL is charged into a 500 m beaker.
(4) Into the beaker are added 5% sodium carbonate aqueous solution 3 g, 5% linear alkylbenzene sulfonate (hereinafter, abbreviated to LAS) aqueous solution 3 g, zeolite 0.1 g, 1% TL400 aqueous solution on solid contents-equivalent basis 2.5 g, and 0.1% polymer aqueous solution on solid contents equivalent basis 2.5 g. Then, the mixture is stirred for 1 minute.
(5) Thereinto are added two White cloths, and the mixture is stirred for 10 minutes.
(6) The white cloths are taken out using tweezers, and hard water 500 mL at 25° C. is charged into the beaker. Then, the mixture is stirred for 2 minutes. This operation is repeated two times.
(7) Each of the white cloths is pressed with a filler cloth to be dried while smoothing wrinkles. The dried clothes are measured for whiteness again as reflectance with the above-mentioned calorimetric difference meter.
(8) From the measurement results, the anti-soil redeposition ratio is determined according to the following formula.

Anti-soil redeposition ratio (%)=(whiteness after cleaning)/(whiteness of original white cloth)×100

The hydrophilized polyalkylene glycol of the present invention has a viscosity decreasing rate of 5% or less under the following conditions, and more preferably, 3% or less. The hydrophilized polyalkylene glycol of the present invention has a low viscosity decreasing rate under such conditions, therefore being excellent in storage stability under alkaline conditions. Therefore, such a glycol of the present invention can be preferably used as a detergent composition, a water-treatment agent, or a dispersant.

### (Storage Stability Test)

(1) With sodium hydroxide aqueous solution, 40% polymer aqueous solution on solid contents equivalent basis is adjusted to pH 10.
(2) The aqueous solution after (1) is maintained in an incubator at 25° C. for 1 hour and then measured for viscosity with DV-1+ type viscometer (product of Brookfield Corp.).
(3) The aqueous solution after (2) is charged into an incubator at 40° C. and maintained for 24 hours.
(4) The aqueous solution after (3) is charged into an incubator at 25° C. and maintained fort hour and then measured for viscosity with the DV-1+ type viscometer.
(5) From the above measurement results, the decreasing rate is determined according to the following formula.

$$\begin{matrix}viscosity \\ decreasing \\ rate ( \% )\end{matrix} = \frac{\begin{matrix}( viscosity before \\ maintenance at 40 ° C . )\end{matrix} - \begin{matrix}( viscosity after \\ maintenance at \\ 40 ° C . for 24 hours )\end{matrix}}{\begin{matrix}viscosity before \\ maintenance at 40 ° C .\end{matrix}} \times 100$$

As mentioned above, it is preferable that the hydrophilized polyalkylene glycol is the sulfonated polyalkylene glycol having a sulfonic acid (salt) group. That is, a detergent composition, a water-treatment agent, or a dispersant, comprising the above-mentioned sulfonated polyalkylene glycol is also part of the preferable embodiments of the present invention.

The hydrophilized polyalkylene glycol of the present invention has the above-mentioned configuration. The present invention relates to: such a hydrophilized polyalkylene glycol which is preferably used in applications such as builders for cleaning agents, cleaning agents, water treatment agents, and dispersants, and sufficiently exhibits high basic performances such as detergency; a production method thereof; and an application thereof.

### BEST MODE FOR CARRYING OUT THE INVENTION

The present invention is described in more detail below with reference to Examples, but the present invention is not limited to only the following Examples. The terms, “part(s)” hand “%” represent “part(s) by weight” and “% by weight”, respectively, unless otherwise specified.

### EXAMPLE 1

Into a glass reactor equipped with a thermometer and a stirrer were charged isoprenol-ethylene-oxide 50 mol adduct 22.9 g and pure water 36.0 g, and thereinto was added sodium hydrogensulfite 1.1 g under stirring. Further, thereinto was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (1) was obtained. Formation of the water-soluble polymer (1) was, identified by the following way.

A proper amount of water was added to the obtained water-soluble polymer (1) to prepare about 50 g of a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cutoff molecular weight equal to that of this dialysis membrane may be used.)

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 30% by weight before the dialysis 20 g was concentrated with an evaporator and then kept standing inside a desiccator under reduced pressure for 12 hours to be dried.

Decrease in polymer weight after the dialysis to the weight of the charged polymer was considered to be residual sodium hydrogensulfite or the total weight of sodium sulfite. Calculation based on this value showed that yield of the reaction product was 96%.

The dry sample after the dialysis was dissolved in D₂O and measured for ¹H-NMR spectrum. The signal derived from the structure in which the double bond of isoprenol was sulfonated was detected near 1.9 to 2.0 ppm and near 2.5 to 2.9 ppm.

Sulfur, contents of the samples before and after the dialysis were compared with each other by Inductively Coupled Plasma (ICP) emission spectrochemical analysis. The sample after the dialysis had a sulfur content of 90%.

The above results identified that the water soluble polymer (1) had a structure in which the sulfonic acid group was added to the double bond of the isoprenol-ethylene oxide 50 mol adduct.

### EXAMPLE 2

Into a glass reactor equipped with a thermometer and a stirrer were charged sorbitol-ethylene oxide 20 mol adduct 54.6 g, and powder potassium hydroxide 0.03 g, and the mixture was stirred at 80° C. for 1 hour. The temperature was lowered to 60° C., and then allyl glycidyl ether 6.8 g was added in the mixture slowly and reaction was performed for 36 hours. Thereby, a water-soluble polymer (2) was obtained. Formation of the water-soluble polymer (2) was identified by the following way.

A proper amount of water was added to the obtained water-soluble polymer (2) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.). This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl-ether. Calculation based on this value showed that yield of the reaction product was 95%.

The dry sample after the dialysis was dissolved in D₂O and measured for ¹H-NMR spectrum. The signal-derived from the double bond of the allyl glycidyl-ether whose epoxy ring was added was detected near 5.20 ppm and 5.80 ppm.

The above results identified that the water-soluble polymer (2) is a polymer in which the epoxy ring of the allyl glycidyl ether was added to sorbitol-ethylene oxide 20 mol adduct.

Into a glass reactor equipped with a thermometer and a stirrer were charged the water-soluble polymer (2) 61.5 g and pure water 102.5 g, and thereinto was added sodium hydrogensulfite 6.9 g under stirring. Further, thereinto was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (3) was obtained. Formation of the water-soluble polymer (3) was identified by the following way.

A proper amount of water was added to the obtained water-soluble polymer (3) to prepare a polymer aqueous solution with a polymer concentration of 30%, by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours-later, and then the outside of the membrane was washed enough with water. Then, the content of the dialysis membrane was removed. The removed content was concentrated with an evaporator and then kept standing for 12 hours ins idea desiccator under reduced pressure to be dried completely.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be residual sodium hydrogensulfite or the total weight of sodium sulfite. Calculation based on this value showed that yield of the reaction product was 96%.

The dry sample after the dialysis was dissolved in D₂O and measured for ¹H-NMR spectrum. The signal derived from the structure in which the double bond of the allyl glycidyl ether was sulfonated was detected near 1.8 to 1.9 ppm and 2.7 to 2.9 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (3) had a structure in which the sulfonic acid group was added to the double bond of the reaction product of sorbitol-ethylene oxide adduct with the alkyl glycidyl ether.

### (Evaluation Test of Anti-Soil Redeposition Ability)

According to the above-mentioned method, the water-soluble polymer (1) and the water-soluble polymer (3) were measured for anti-soil redeposition ability. For comparison, anti-soil redeposition ability in the following cases was measured in the cases where the water-soluble polymer was not added; and PEG 4000 (polyethylene glycol (number average molecular weight of 3000) was added instead of the water-soluble polymer. Table 1 shows the results. With respect to the hardness in these cases, CaCO₃ concentration was 50 ppm (low hardness condition).

TABLE 1

| | Water-soluble | Water-soluble | | |
|---|---|---|---|---|
| | polymer (1) | polymer (3) | PEG4000 | No polymer |
| Anti-soil | 84.6 | 85.0 | 79.4 | 57.7 |
| redeposition | | | | |
| ratio(%) | | | | |

### EXAMPLE 3

### Sulfonated Sorbitol Ethylene Oxide 10 mol Adduct

Into a glass reactor equipped with a thermometer and a stirrer were charged a sulfonated sorbitol ethylene oxide 10 mol adduct (SB600) 28.1 g and maintained at 60° C. Thereinto was added allyl glycidyl ether 6.8 g slowly and the mixture was stirred to be homogeneous. Further, thereinto was added a boron tridifluoride diethylether complex 0.3 mL under stirring and reaction was performed for 36 hours to obtain a water-soluble polymer (4). Formation of the water-soluble polymer (4) was identified by the following way.

A proper amount of water was added to the obtained water-soluble polymer (4) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.). This was soaked in water 2000 g in a 2 L beaker, and stirred with a stirrer. The dialysis membrane was removed from the beaker 3 hours later, and then the outside of the membrane was washed enough with water.

Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl ether. Calculation based on this value showed that yield of the reaction product was 95%.

The dry sample after the dialysis was dissolved in D₂O and measured for ¹H-NMR spectrum. The signal derived from the double bond of the allyl glycidyl ether whose epoxy ring was added Was detected near 5.20 ppm and 5.80, ppm.

The above results identified that the water soluble polymer (4) was a polymer in which the epoxy ring of the allyl glycidyl ether was added to SB 600.

Into a glass reactor equipped with a thermometer and a stirrer were charged the water-soluble polymer (4) 17.5 g and pure water 48.1 g, and thereinto was added sodium hydrogensulfite 3.1 g under stirring. Further, thereinto was added a small amount of 48% sodium hydroxide and thereby the solution was adjusted to pH 9. Under stirring, this polymer aqueous solution was reacted for 8 hours at room temperatures with the reactor open.

Thereby, a water-soluble polymer (5) was obtained. Formation of the water-soluble polymer (5) was identified by the following way.

A proper amount of water was added to the obtained water-soluble polymer (5) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred, with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 3.0% by weight before the dialysis 20 g was concentrated with an evaporator and then kept standing inside a desiccator for 12 hours under reduced pressure to be dried.

Decrease in polymer weight after the dialysis to the weight of the charged polymer was considered to, be residual sodium hydrogensulfite or the total weight of sodium sulfite. Calculation based on this value showed that yield of the reaction product was 95%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (5) had a structure in which the sulfonic acid group was added to the double bond of the water-soluble polymer (4).

### EXAMPLE 4

### Sulfonated SOFTANOL Ethylene Oxide 90 mol Adduct

Into a glass reactor equipped with a thermometer and a stirrer were charged a SOFTANOL ethylene oxide 90 mol adduct (hereinafter, referred to as SFT 1000) 413.2 g and maintained at 60° C. There into was added allyl glycidyl ether 11.4 g slowly and the mixture was stirred to be homogeneous. Further, thereinto was added a boron tridifluoride diethylether complex 3.0 mL under stirring and reaction was performed for 3.6 hours to obtain a water-soluble polymer (6). Formation of the water-soluble polymer (6) was identified by the following way.

A proper amount of water was added to the obtained water-soluble polymer (6) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.) This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl ether. Calculation based on this value showed that yield of the reaction product was 93%.

The dry sample after the dialysis was dissolved in D₂O and measured for ¹H-NMR spectrum. The signal derived from the double bond of the allyl glycidyl ether whose epoxy ring was added was detected near 5.20 ppm and 5.80 ppm.

The above results identified that the water-soluble polymer (6) was a polymer in which the epoxy ring of the allyl glycidyl ether was added to SFT 1000.

Into a glass reactor equipped with a thermometer and a stirrer were charged the water-soluble polymer (6) 21.2 g and pure water 87.0 g, and thereinto was added sodium hydrogensulfite 0.5 g was added under stirring. Further, thereinto was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (7) was obtained. Formation of the water-soluble polymer (7) was identified by the following way.

A proper amount of water was added to the obtained water-soluble polymer (7) to prepare a polymer aqueous solution with a polymer concentration of 20% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 20% by weight before the dialysis 20 g was concentrated with an evaporator and then kept standing inside a desiccator for 12 hours under reduced pressure to be dried.

Decrease in polymer weight after the dialysis to the weight of the charged polymer was considered to be residual sodium hydrogensulfite or the total weight of sodium sulfite. Calculation based on this value showed that yield of the reaction product was 91%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (7) had a structure in which the sulfonic acid group was added to the double bond of the water-soluble polymer (6)

### EXAMPLE 5

### Sulfonated SOFTANOL Ethylene Oxide 60 mol Adduct

Into a glass reactor equipped with a thermometer and a stirrer were charged a SOFTANOL ethylene oxide 60 mol adduct (SFT 600) 263.6 g and maintained at 60° C. Thereinto was added allyl glycidyl ether 11.4 g slowly and the mixture was stirred to be homogeneous. Further, thereinto was added a boron tridifluoride diethylether complex 3.0 mL under stirring and reaction was performed for 36 hours to obtain a water-soluble polymer (8). Formation of the water-soluble polymer (8) was identified by the following way.

A proper amount of water was added to the obtained water-soluble polymer (8) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.) This was soaked in water 2000 g in a 2 L beaker, and stirred with a stirrer. The dialysis membrane was removed from the beaker 3, hours later, and then the outside of the membrane was washed enough with water. Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl ether. Calculation based on this value showed that yield of the reaction product was 94%.

The dry sample after the dialysis was dissolved in D₂O and measured for ¹H-NMR spectrum. The signal derived from the double bond of the allyl glycidyl ether whose epoxy ring was added was detected near 5.20 ppm and 5.80 ppm.

The above results identified that the water-soluble polymer (8) was a polymer in which the epoxy ring of the allyl glycidyl ether was added to SFT 600.

Into a glass reactor equipped with a thermometer and a stirrer were charged the water-soluble polymer (8) 13.8 g and pure water 57.1 g, and thereinto sodium hydrogensulfite 0.5 g was added under stirring. Further, thereinto was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (9) was obtained. Formation of the water-soluble polymer (9) was identified by the following way.

A proper amount of water was added to the obtained water-soluble polymer (9) to prepare a polymer aqueous solution with a polymer concentration of 20% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 20% by weight before the dialysis 20 g was concentrated with an evaporator and then kept standing inside a desiccator for 12 hours under reduced pressure to be dried.

Decrease in polymer weight after the dialysis to the weight of the charged polymer was considered to be residual sodium hydrogensulfite or the total weight of sodium sulfite. Calculation based on this value showed that yield of the reaction product was 93%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (9) had a structure in which the sulfonic acid group was added to the double bond of the water-soluble polymer (8).

### EXAMPLE 6

Into a glass reactor equipped with a thermometer and a stirrer were charged a SOFTANOL (SFT 500) 238.4 g and maintained at 60° C. Thereinto was added allyl glycidyl ether 11.4 g slowly and the mixture was stirred to be homogeneous. Further, thereinto was added a boron tridifluoride diethyl ether complex 1.0 mL under stirring and reaction was performed for 36 hours to obtain a water-soluble polymer (10). Formation of the water-soluble polymer (1.0) was identified by the following way.

A proper amount of water was added to the obtained water-soluble polymer (10) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.). This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl ether. Calculation based on this value showed that yield of the reaction product was 96%.

The dry sample after the dialysis was dissolved in D₂O and measured for ¹H-NMR spectrum. The signal derived from the double bond of the allyl glycidyl ether whose epoxy ring was added was detected near 5.20 ppm and 5.80 ppm.

The above results identified that the water-soluble polymer (10) was a polymer in which the epoxy ring of the allyl glycidyl ether was added to SFT 200.

Into a glass reactor equipped with a thermometer and a stirrer were charged the water-soluble polymer (10) 7.5 g and pure water 31.0 g, and thereinto sodium hydrogensulfite 0.5 g was added under stirring. Further, therein was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (11) was obtained. Formation of the water-soluble polymer (11) was identified by the following way.

A proper amount of water was added to the obtained water-soluble polymer (11) to prepare a polymer aqueous solution with a polymer concentration of 30% by weight. A dialysis membrane in 40 cm length was filled with this polymer aqueous solution 20 g. and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be residual sodium hydrogensulfite or the total weight of sodium sulfite. Calculation based on this value showed that yield of the reaction product was 93%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (11) had a structure in which the sulfonic acid group was added to the double bond of the water-soluble polymer (10).

### EXAMPLE 7

### Phosphated SOFTANOL Ethylene Oxide 50 mol Adduct

Into a glass reactor equipped with a cooling tube, a thermometer, and a stirrer was charged the water-soluble polymer (10) 12.5 g, pure water 52.8 g, and thereinto were added 50% phosphorous acid 0.8 g and 48% sodium hydroxide 0.8 g under stirring. Then, the mixture was heated to the boiling point. Thereinto 15% sodium persulfate 3.2 g was slowly added over 2 hours. The temperature was maintained at the boiling point for one more hour, and then cooled to a room temperature. Thereby, a water-soluble polymer (12) was obtained. Formation of the water-soluble polymer (12) was identified by the following way.

A proper amount of water was added to the obtained water-soluble polymer (12) to prepare a polymer aqueous solution with a polymer concentration of 20% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 20% by weight before the dialysis 20 g was concentrated with an evaporator and then kept standing inside a desiccator for 12 hours under reduced pressure to be dried.

Decrease in polymer weight after the dialysis to the weight of the charged polymer was considered to be residual phosphorous acid or the total weight of sodium phosphite. Calculation based on this value showed that yield of the reaction product was 76%.

The dry sample after the dialysis was dissolved in D₂O and measured for ¹H-NMR spectrum. The signal derived from the structure in which the double bond of the alkylglycidyl ether was phosphated was detected near 1.8 ppm and 2.8 ppm.

Phosphorous contents of the samples before and after the dialysis were compared with each other by Inductively Coupled Plasma (ICP) emission spectrochemical analysis. The sample after the dialysis had a phosphorus content of 72%.

The above results identified that the water-soluble polymer (12) had a structure in which the phosphono group was added to the double bond of the water-soluble polymer (10).

### EXAMPLE 8

### Synthetic Example of Sulfonated SOFTANOL

Into a glass reactor equipped with a thermometer and a stirrer were charged 212.8 g of SFT 200 and maintained at 60° C. Thereinto was added allyl glycidyl ether 22.8 g slowly and the mixture was stirred to be homogeneous. Further, thereinto was added a boron tridfluoride diethylether complex 1.0 mL under stirring and reaction was performed for 36 hours too obtain ac water-soluble polymer (13) Formation of the water-soluble polymer (13) was identified by the following way.

A proper amount of water was added to the obtained water-soluble polymer (13) to prepare a polymer aqueous solution with a polymer concentration of 30% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.). This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried.

For comparison, the polymer aqueous solution with a polymer concentration of 30% by weight before the dialysis 20 g was concentrated with an evaporator and then kept standing inside a desiccator for 12 hours under reduced pressure to be dried.

Decrease in polymer weight after the dialysis to the weight of the charged polymer was considered to be weight of residual allyl glycidyl ether. Calculation based on this value showed that yield of the reaction product was 96%.

The dry sample after the dialysis was dissolved in D₂O and measured for ¹H-NMR spectrum. The signal derived from the double bond of the allyl glycidyl ether whose epoxy ring was added was detected near 5.20 ppm and 5.80 ppm.

The above results identified that the water-soluble polymer (13) was a polymer in which the epoxy ring of the allyl glycidyl ether was added to SFT 200.

Into a glass reactor equipped with a thermometer and a stirrer were charged the water-soluble polymer (13), 11.8 g and pure water 51.3 g, and thereinto sodium hydrogensulfite 1.11 g was added under stirring. Further, thereinto was added a small amount of 48% sodium hydroxide and thereby the solution was adjusted to pH 9. Under stirring, this polymer aqueous solution was reacted for 8 hours at room temperatures with the reactor open. Thereby, a water-soluble polymer (14) was obtained. Formation of the water-soluble polymer (14) was identified by the following way.

A proper amount of water was added to the obtained water-soluble polymer (14) to prepare a polymer aqueous solution with a polymer concentration of 30,% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be dried completely.

For comparison, the polymer aqueous solution with a polymer concentration of 30% by weight before the dialysis 20 g was concentrated with an evaporator and then kept standing inside a desiccator for 12 hours under reduced-pressure to be dried.

Decrease in polymer weight after the dialysis to the weight of the charged polymer was considered to be residual sodium hydrogensulfite or the total weight of sodium sulfite. Calculation based on this value showed that yield of the reaction product was 93%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water soluble polymer (14) had a structure in which the sulfonic acid group was added to the double bond of the water-soluble polymer (13).

### EXAMPLE 9

Into a glass reactor equipped with a thermometer and a stirrer were charged isoprenol-ethyleneoxide 50 mol adducts 5.7 g and maintained at 60° C. Thereinto was added phenyl glycidyl ether 3.0 g slowly and the mixture was stirred to be homogeneous. Further, thereinto was added a boron tridifluoride diethylether complex 0.2 mL under stirring and reaction was performed for 36 hours to obtain a water-soluble polymer (15). Formation of the water-soluble polymer (15) was measured by ¹H-NMR spectrum and identified through decrease in signal derived from the epoxy ring of the phenyl glycidyl ether.

Then, into a glass reactor equipped with a thermometer and a stirrer were charged the polymer (15) 14.0 g, and pure water 56.0 g, and thereinto was added sodium hydrogensulfite 0.6 g under stirring. Further, thereinto was added a small amount of 48% sodium hydroxide and thereby the solution was adjusted reacted for 8 hours at room temperatures with the reactor open.

Thereby a water-soluble polymer-(16) was obtained. Formation of the water-soluble polymer (16) was identified by the following way.

A proper amount of water was added to the obtained water-soluble polymer (16) to prepare a polymer aqueous solution with a polymer concentration of 20% by weight. A dialysis membrane in 40 cm length was filled with this polymer aqueous solution 20 g and then sealed. Spectra/Por Membrane MWCO:1000 cut off molecular weight 1000 (product of SPECTRUM LABORATORIES INC.) was used as the dialysis membrane, (In the present invention, a dialysis membrane having a cut off molecular weight equal to that of this dialysis membrane may be used.).

This was soaked in water 2000 g in a 2 L beaker, and stirred with a stirrer. The dialysis membrane was removed from the beaker 3 hours later, and then the outside of the membrane was washed enough with water. Then, the content of the dialysis membrane was removed. The removed content was concentrated with an evaporator and then kept standing for 12 hours inside a desiccator under reduced pressure to be completely dried.

For comparison, the polymer aqueous solution with a polymer concentration of 20% by weight before the dialysis 20 g was concentrated with an evaporator and then kept, standing inside a desiccator for 12 hours under reduced pressure to be dried.

Decrease in polymer weight after the dialysis to the weight of the charged polymer was considered to be residual sodium hydrogensulfite or the total weight of sodium sulfite. Calculation based on this value showed that yield of the reaction product was 95%.

The dry sample after the dialysis was dissolved in D₂O and measured for ¹H-NMR spectrum. The signal derived from the structure in which the double bond of the allyl glycidyl ether was sulfonated was detected near 1.8 ppm and 2.8 ppm.

Sulfur contents of the samples before and after the dialysis were compared with each other by Inductively Coupled Plasma (ICP) emission spectrochemical analysis. The sample after the dialysis had a sulfur content of 90%.

The above results identified that the water-soluble polymer (16) had a structure in which the sulfonic acid group was added to the double bond of the water-soluble polymer (15).

### (Anti-Soil Redeposition Ability Test Under High Hardness Condition)

The water-soluble polymers (11) and (14) were measured for anti-soil redeposition ability in the same manner as in the above-mentioned evaluation test of anti-soil redeposition ability, except that not 0.368 g but 1.47 g of calcium chloride dihydrate was used. For comparison, anti-soil redeposition ability in the following cases was measured: in the cases where the water-soluble polymer was not added; PEG 2000 (polyethylene glycol (number average molecular weight of 2000)) was added instead of the water-soluble polymer; and PEG 4000 (polyethylene glycol (number average molecular weight of 3000)) was added instead of the water-soluble polymer. With respect to the hardness in these cases, CaCO₃ concentration was 200 ppm (high hardness condition). Table 2 shows the results.

TABLE 2

| | Water-soluble | Water-soluble | Water-soluble | | | |
|---|---|---|---|---|---|---|
| | polymer (3) | polymer (11) | polymer (14) | PEG4000 | PEG2000 | No polymer |
| Anti-soil | 53.8 | 51.5 | 51.9 | 51.1 | 37.3 | 35.1 |
| redeposition ratio (%) | | | | | | |

The above-mentioned Examples and comparative examples show the following significance of critical range of the present invention. That is, due to the polyalkylene glycol chain and the hydrophilic group at the terminal, the hydrophilized polyalkylene glycol of the present invention exhibits advantageous effects in anti-soil redeposition ability under both high hardness and low hardness conditions, and such effects are remarkably exhibited.

The sulfonic acid group was used as a hydrophilic group in the above-mentioned Examples and comparative examples. However, the mechanism in which the anti-soil redeposition ability is exhibited is not changed as long as the hydrophilized polyalkylene glycol is contained, even though any hydrophilic group is used as the hydrophilic group. Accordingly, the hydrophilized polyalkylene glycol can surely exhibits the advantageous effects of the present invention if having a hydrophilic group such as —SO₃M, —S—CH₂—CH₂—SO₃M, —PO₃M₂, and —S—(CH₂)ₜ—COOM at the terminal. At least with respect to the cases where the hydrophilized polyalkylene glycol has a sulfonic acid group such as a hydrophilic group, the above-mentioned Examples and comparative examples sufficiently prove the advantageous effects of the present invention and support the technical meaning of the present invention.

1. A hydrophilized polyalkylene glycol represented by the following formula (1): 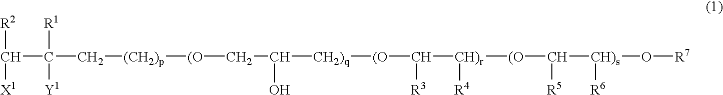
in the formula, X¹ and Y¹ being different from each other, and each representing a hydrogen atom, —SO₃M, —S—CH₂—CH₂—SO₃M, —PO₃M₂, or —S—(CH₂)ₜ—COOM;
M representing a hydrogen atom, an alkali metal atom, an alkali earth metal atom, an ammonium group, or an organic ammonium group;
R¹ and R² being the same or different, and each representing a hydrogen atom or an alkyl group containing 1 to 4 carbon atoms, but not representing a methyl group simultaneously;
R³ and R⁴ being the same or different, and each representing a hydrogen atom or an alkyl group containing 1 to 4 carbon atoms, but not representing an alkyl group simultaneously;
R⁵ and R⁶ being the same or different, and each representing a hydrogen atom or an alkyl group containing 1 to 4 carbon atoms, but not representing an alkyl group simultaneously;
R⁷ representing a hydrogen atom, an alkyl group containing 1 to 14 carbon atoms, an aryl group containing 6 to 10 carbon atoms, a polyhydric alcohol group containing 2 to 8 carbon atoms, Z¹ represented by the following formula (2-1), or Z² represented by the following formula (2-2);
p, q, r, and s each representing a valency;
p being an integer of 0 to 5;
q being 0 or 1;
r+s being an integer of 3 to 100; 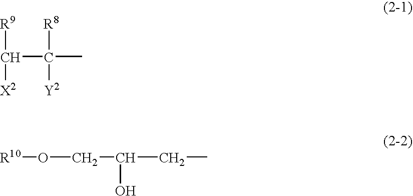
in the formula, X² and Y² being different from each other, and each representing a hydrogen atom, —SO₃M, —S—CH₂—CH₂—SO₃M, —PO₃M₂, or —S—(CH₂)ₜ—COOM;
M representing a hydrogen atom, an alkali metal atom, an alkali earth metal atom, an ammonium group, or an organic ammonium group;
R⁸ and R⁹ being the same or different, and each representing a hydrogen atom or an alkyl group containing 1 to 4 carbon atoms, but not representing a methyl group simultaneously; and
R¹⁰ representing an alkyl group containing 1 to 15 carbon atoms or an aryl group containing 6 to 10 carbon atoms.

2. The hydrophilized polyalkylene glycol according to claim 1,
wherein the R¹ represents a methyl group, the R² represents a hydrogen atom, the p is 1, and the q is 0.

3. The hydrophilized polyalkylene glycol according to claim 1,
wherein each of the R¹ and the R² represents a hydrogen atom, and each of the p and the q is 0.

4. The hydrophilized polyalkylene glycol according to claim 2,
wherein the s is 0, and each of the R³, the R⁴, and the R⁷ represents a hydrogen atom.

5. The hydrophilized polyalkylene glycol according to claim 2,
wherein the s is 0, each of the R³ and the R⁴ represents a hydrogen atom, and the R⁷ represents the Z².

6. The hydrophilized polyalkylene glycol according to claim 1,
wherein each of the R¹ and the R² represents a hydrogen atom; the p is 0; and the q is 1.

7. The hydrophilized polyalkylene glycol according to claim 6,
wherein the s is 0;
each of the R³ and the R⁴ represents a hydrogen atom; and
the R⁷ represents an alkyl group containing 1 to 14 carbon atoms or a polyhydric alcohol group containing 2 to 8 carbon atoms.

8. The hydrophilized polyalkylene glycol according to claim 1,
wherein the X¹ and the Y¹ are different from each other and each represent a hydrogen atom or —SO₃M.

9. The hydrophilized polyalkylene glycol according to claim 1,
wherein the hydrophilized polyalkylene glycol has an anti-soil redeposition ability of 80% or more in an aqueous solution with a CaCO₃ concentration of 50 ppm.

10. The hydrophilized polyalkylene glycol according to claim 1,
wherein the hydrophilized polyalkylene glycol has an anti-soil redeposition ability of 40% or more in an aqueous solution with a CaCO₃ concentration of 200 ppm.

11. A sulfonated polyalkylene glycol comprising a polyalkylene oxide and a sulfonic acid (salt) group,
wherein the sulfonated polyalkylene glycol has an anti-soil redeposition ability of 40% or more in an aqueous solution with a CaCO₃ concentration of 200 ppm and contains no ester bond.

12. A production method of a hydrophilized polyalkylene glycol, the method comprising a step of hydrophilizing a double bond of a polyalkylene glycol with the double bond,
wherein the step is performed using a raw material containing no halide.

13. The production method of the hydrophilized polyalkylene glycol according to claim 12,
wherein the hydrophilized polyalkylene glycol is represented by the following formula (1), and the hydrophilized polyalkylene glycol is produced by hydrophilizing a double bond of a polyalkylene glycol with the double bond represented by the following formula (3): 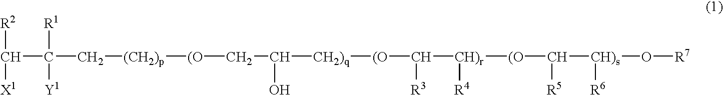
in the formula, X¹ and Y¹ being different from each other, and each representing a hydrogen atom, —SO₃M, —S—CH₂—CH₂—SO₃M, —PO₃M₂, or —S—(CH₂)ₜ—COOM;
M representing a hydrogen atom, an alkali metal atom, an alkali earth metal atom, an ammonium group or an organic ammonium group;
R¹ and R² being the same or different from each other, and each representing a hydrogen atom or an alkyl group containing 1 to 4, but not representing a methyl group simultaneously;
R³ and R⁴ being the same or different, and each representing a hydrogen atom or an alkyl group containing 1 to 4 carbon atoms, but not representing an alkyl group;
R⁵ and R⁶ being the same or different, and each representing a hydrogen atom or an alkyl group containing 1 to 4 carbon atoms, but not representing an alkyl group;
R⁷ representing a hydrogen atom, an alkyl group containing 1 to 14 carbon atoms, an aryl group containing 6 to 10 carbon atoms, a polyhydric alcohol group containing 2 to 8 carbon atoms, Z¹ represented by the following formula (2-1), or Z² represented by the following formula (2-2);
p, q, r, and s each representing a valency;
p being an integer of 0 to 5;
q being 0 or 1;
r+s being an integer of 3 to 100; 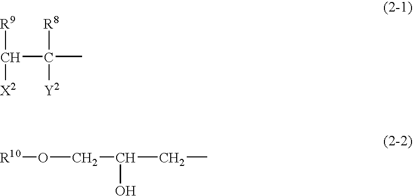
in the formula, X² and Y² being different from each other, and each representing a hydrogen atom, —SO₃M, —S—CH₂—CH₂—SO₃M, —PO₃M₂, or —S—(CH₂)ₜ—COOM;
M representing a hydrogen atom, an alkali metal atom, an alkali earth metal atom, an ammonium group, or an organic ammonium group;
R⁸ and R⁹ being the same or different, and each representing a hydrogen atom or an alkyl group containing 1 to 4 carbon atoms, but not representing a methyl group simultaneously;
R¹⁰ representing an alkyl group containing 1 to 15 carbon atoms or an aryl group containing 6 to 10 carbon atoms, 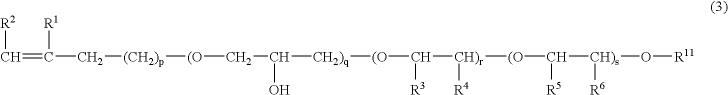
in the formula, R¹, R², R³, R⁴, R⁵, and R⁶ are the same as those in the above formula (1), respectively;
R¹¹ representing a hydrogen atom, an alkyl group containing 1 to 14 carbon atoms, an aryl group containing 6 to 10 carbon atoms, a polyhydric alcohol group containing 2 to 8 carbon atoms, or Z³ represented by the following formula (4), or the Z² represented by the above formula (2-2);
p, q, r and s being the same as those in the above formula (1), respectively, 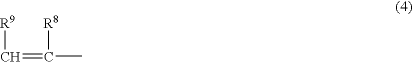
in the formula, R⁸ and R⁹ being the same as those in the above formula (2-1), respectively.

14. A detergent composition, a water-treatment agent, or a dispersant, comprising the hydrophilized polyalkylene glycol according to claim 1.

15. The hydrophilized polyalkylene glycol according to claim 3,
wherein the s is 0, and each of the R³, the R⁴, and the R⁷ represents a hydrogen atom.

16. The hydrophilized polyalkylene glycol according to claim 3,
wherein the s is 0, each of the R³ and the R⁴ represents a hydrogen atom, and the R⁷ represents the Z².

17. The hydrophilized polyalkylene glycol according to claim 2,
wherein the X¹ and the Y¹ are different from each other and each represent a hydrogen atom or —SO₃M.

18. The hydrophilized polyalkylene glycol according to claim 3,
wherein the X¹ and the Y¹ are different from each other and each represent a hydrogen atom or —SO₃M.

19. The hydrophilized polyalkylene glycol according to claim 4,
wherein the X¹ and the Y¹ are different from each other and each represent a hydrogen atom or —SO₃M.

20. The hydrophilized polyalkylene glycol according to claim 5,
wherein the X¹ and the Y¹ are different from each other and each represent a hydrogen atom or —SO₃M.
